(19) United States
(12) Patent Application Publication
(10) Pub. No.: US 2014/0254408 A1
(43) Pub. Date: Sep. 11, 2014

(54) RATE CONTROL ASSOCIATED WITH FRAME AGGREGATION

(71) Applicant: QUALCOMM Incorporated, San Diego, CA (US)

(72) Inventors: Ashish Kumar Shukla, Sunnyvale, CA (US); Naveen Pratap Singh, San Jose, CA (US); Shu Du, Milpitas, CA (US); Qinghai Gao, Sunnyvale, CA (US); Zhanfeng Jia, Belmont, CA (US); Vishnu Vardhan Bala Krishnan, San Diego, CA (US)

(73) Assignee: QUALCOMM Incorporated, San Diego, CA (US)

(21) Appl. No.: 14/038,027

(22) Filed: Sep. 26, 2013

Related U.S. Application Data
(60) Provisional application No. 61/775,436, filed on Mar. 8, 2013.

(51) Int. Cl. H04L 1/00; H04W 24/02

(52) U.S. Cl. CPC H04L 1/0002; H04W 24/02
USPC 370/252

(57) ABSTRACT

MAC layer frame aggregation and block acknowledgement are used in some WLAN technologies to improve efficiency of a communications channel by reducing PHY layer overhead. A frame aggregation window size defines how many MAC protocol data units (MPDUs) are included in an aggregated MPDU (AMPDU) frame. The frame aggregation window for a subsequent AMPDU frame is typically dependent upon the characteristics of the block acknowledgement—such as the number of non-acknowledged (NAK) MPDUs or the position of a hole in the previous AMPDU frame. A small frame aggregation window size may impact throughput especially at higher transmission rates. In this disclosure a transmission rate may be determined based, at least in part, on a projected frame aggregation window size resulting from a block acknowledgement. The frame aggregation feedback (e.g. block acknowledgement) may be used by a rate control module to determine a transmission rate that optimizes frame aggregation efficiency.

### RELATED APPLICATIONS

This application claims the priority benefit of U.S. Provisional Patent Application Ser. No. 61/775,436 filed Mar. 8, 2013.

### BACKGROUND

Embodiments of the present subject matter generally relate to the field of communication systems, and, more particularly, to communication systems that utilize frame aggregation.

Many factors impact the efficiency of communication systems. For example, physical layer (PHY) transmission properties, media access control layer (MAC) protocols, and environmental factors may all impact the total throughput of communications via a communications channel. When the communications channel has improved channel conditions, then higher data rates may be reliably transmitted. However, when the communications channel has increased noise and/or interference, it may be preferable to adjust PHY transmission properties or MAC protocol options to maximize the throughput.

As communications technology has evolved, faster PHY transmission rates are possible. For example, the use of orthogonal frequency-division multiplexing (OFDM) modulation techniques, enhanced modulation and coding schemes (MCS), and the use of multiple-input multiple-output (MIMO) antennas are among the examples of technology that have increased the physical layer transmission rates achievable by a communications channel. In addition to faster transmission rates, improvements in MAC protocols have also increased throughput. For example, reducing MAC protocol overhead has shown to improve throughput in communication systems. For example, frame aggregation is a process of arranging several MAC protocol data units (MPDUs) together into a single PHY transmission frame. Having fewer PHY transmission frames is preferable in some communication systems that define a contention process between PHY frames, interframe spacing, or PHY transmission frame headers (PHY overhead).

Further improvements to throughput may be possible in communications systems that employ frame aggregation feedback in the form of block acknowledgement. Block acknowledgment is a mechanism for a receiver to acknowledge multiple MPDUs (associated with frame aggregation) in a single block acknowledgement message.

### SUMMARY

Various embodiments are described in which a transmission rate is determined based at least in part on frame aggregation characteristics. For example, a projected frame aggregation window size may be determined based, at least in part, on block acknowledgement. The projected frame aggregation window size (or an associated frame aggregation shift parameter) may be used by a rate control module to determine an appropriate physical layer (PHY) transmission rate for the communications channel. The PHY transmission rate may be selected based on optimizing overall throughput resulting from different frame aggregation window sizes for various PHY transmission rates.

In one embodiment, a transmission rate used for transmissions via a communications channel is adjusted based at least in part upon a frame aggregation shift parameter derived from frame aggregation feedback information.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a system diagram and example operations illustrating an example embodiment of rate control based on frame aggregation feedback.

FIG. 2 is a diagram illustrating an example network device having a rate control module in accordance with an embodiment of the present disclosure.

FIG. 3 is a diagram illustrating an example AMPDU frame format in accordance with an embodiment of the present disclosure.

FIG. 4 is a diagram illustration an example block acknowledgement frame format in accordance with an embodiment of the present disclosure.

FIG. 5 is a message flow diagram illustrating a frame aggregation, frame aggregation feedback, and rate control in accordance with an embodiment of the present disclosure.

FIG. 6 is a flow diagram illustrating example operations associated with processing frame aggregation feedback in accordance with an embodiment of the present disclosure.

FIG. 7 is a flow diagram illustrating example operations associated with determining a transmission rate based on frame aggregation feedback in accordance with an embodiment of the present disclosure.

FIG. 8 is a conceptual illustration showing several examples of frame aggregation feedback in accordance with an embodiment of the present disclosure.

FIG. 9 is a table illustrating an example of determining a transmission rate based, at least in part, on frame aggregation in accordance with an embodiment of the present disclosure.

FIG. 10 is an example block diagram of one embodiment of an electronic device including a rate control module in accordance the present disclosure.

### DESCRIPTION OF EMBODIMENT(S)

The description that follows includes exemplary systems, methods, techniques, instruction sequences and computer program products that embody techniques of the present subject matter. However, it is understood that the described embodiments may be practiced without these specific details. For instance, although examples refer to certain wireless communications protocols, rate control may be improved in a variety of communications medium configured to utilize frame aggregation and frame aggregation feedback. In other instances, well-known instruction instances, protocols, structures and techniques have not been shown in detail in order not to obfuscate the description.

Frame aggregation (also referred to as MPDU aggregation or MAC layer aggregation) is a technique in which MAC protocol data units (MPDUs) are aggregated into a single PHY transmission frame. An Aggregated MPDU (AMPDU) includes a number of MPDU delimiters each followed by an MPDU. The transmission frame that includes aggregated MPDUs may be referred to as an AMPDU frame or transmission. A frame aggregation scheme was introduced in IEEE 802.11e standard for wireless local area networks (WLANs) as a MAC-layer enhancement for reducing the PHY protocol timing overheads. IEEE 802.11n standard provided improvements to the frame aggregation scheme and improvements to feedback messages associated with frame aggregation. Other technologies (including other wireless or wire line technologies) may also utilize frame aggregation and feedback.

An example of frame aggregation feedback is a block acknowledgement (BA) message. Block Acknowledgment is a mechanism for a recipient of an AMPDU transmission to acknowledge multiple MPDUs in a single BA frame. Typically the BA frame includes a bitmap which identifies acknowledgement (often indicated as a “1” value) or non-acknowledgement (often indicated as a “0” value) for particular MPDUs in the AMPDU transmission. Each bit of the bitmap typically represents an indication whether the recipient successfully received and decoded a MPDU. A compressed block acknowledgement is a form of a BA frame that has a smaller bitmap and may be used for feedback of AMPDUs that only include non-fragmented MPDUs.

In a traditional communication system, a transmitting station receives a BA frame from a recipient station to indicate success/failure of the MPDUs in an AMPDU frame. The transmitting station may adjust the quantity of MPDUs included in the next AMPDU. For example, a transmitting station may reduce the number of MPDUs in the subsequent AMPDU frame based on feedback that indicates errors in the previous AMPDU frame. Currently the standard for some WLAN networks allow up to 64 MPDUs to be included in an AMPDU frame. The quantity of MPDUs included in an AMPDU may also be referred to as an aggregation window size. An adaption algorithm may change the quantity of MPDUs in subsequent AMPDUs based on which MPDU failed in the previous AMPDU. However, this may result in an unnecessarily small AMPDU window size.

In accordance with this disclosure, a transmitting station may determine a transmission rate based on frame aggregation feedback. In one example, frame aggregation techniques may be improved by reducing a PHY transmission rate so that a larger aggregation window size is possible. In one embodiment, the feedback included in a block acknowledgement frame may be used to determine whether the transmission rate should be changed. For example, the frame aggregation efficiency of a system may be dependent upon the frame aggregation window size that would result from a failed MPDU in a previous AMPDU message. In one example, rather than changing the frame aggregation window size, the transmission rate is changed so that frame aggregation can include a larger window size at a different transmission rate.

In accordance with this disclosure, impact of frame aggregation may be used by a rate control module for determining PHY transmission rate. The impact of frame aggregation may be used by the rate control module to determine the PHY transmission rate by adjusting a packet error rate based on aggregation size or by using aggregation size as a separate parameter in a rate control process. In another example, a goodput calculation may incorporate the impact of frame aggregation prior to selecting a transmission rate based on the calculated goodput for particular transmission rates.

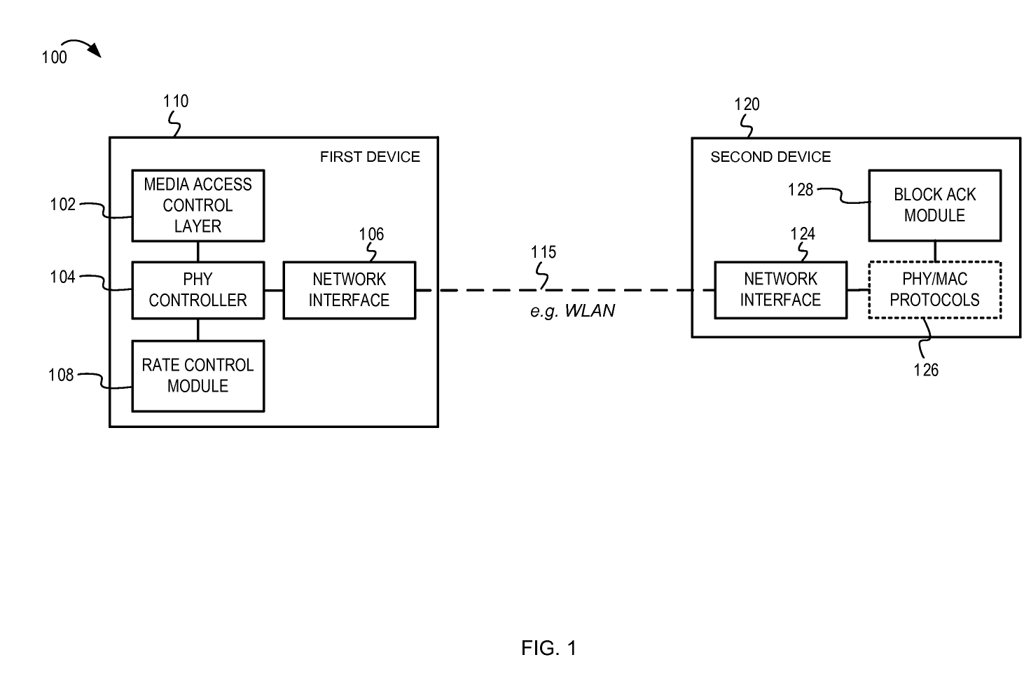

FIG. 1 is a system 100 illustrating an example embodiment of rate control based on frame aggregation feedback. A first device 110 includes a MAC layer 102, a PHY controller 104, and a network interface 106. The network interface 106 is capable of being coupled to a communications channel 115. The communications channel may be wireless or wire line. In one example, the communications channel 115 is a WLAN wireless channel configured for IEEE 802.11e, IEEE 802.11n, IEEE 802.11 ac or other types of WLAN protocols which utilize frame aggregation techniques. The MAC layer 102 includes functionality to implement frame aggregation and cause an AMPDU frame to be transmitted via the network interface 106.

The system 100 may include a second device 120 that has a network interface 124 and PHY/MAC protocols 126. The second device 120 includes a block acknowledgement module 128 (referred to as Block Ack module) configured to send a BA frame to the first device 110 to indicate acknowledgement/non-acknowledgement (ACK/NAK) for a series of MPDUs included in the AMPDU frame transmitted from the first device 110 to the second device 120.

First device 110 also includes a rate control module 108. In a traditional device, the rate control module may adjust the PHY transmission rate based on channel conditions, such as bit error rate, signal to noise ratio, or power limitations. The rate control module can adjust the modulation and coding scheme (MCS) used over the communications channel 115. For example, different MCS may be associated with different data transmission rates. MCS involves the coding of data into symbols in a modulation scheme. A greater number of symbols may allow for a greater number of bits to be represented by each symbol. Therefore, a higher MCS indicates modulation using greater numbers of bits for each symbol. A higher MCS is associated with a higher PHY transmission rate since more data can be communicated in each transmission.

In accordance with this disclosure, the rate control module 108 is configured to determine the transmission rate based at least in part upon the frame aggregation efficiency that would result for different transmission rates. For example, if a higher MCS results in greater MPDU failures then the frame aggregation window would be smaller. A smaller frame aggregation window may limit throughput of MPDUs for the higher MCS. Alternatively, the rate control module 108 may select a lower MCS. Even though the lower MCS may result in a lower bit rate, the lower MCS may support a larger frame aggregation window. The larger frame aggregation window can reduce PHY overhead and improves the frame aggregation efficiency of the communications channel. This disclosure includes various alternatives for determining an optimal transmission rate based, at least in part, on the frame aggregation feedback.

Having described the structural and logical components of the system 100 in FIG. 1, various example operations are now described with respect to the system 100.

At stage A, the first device transmits a first quantity of MPDUs using frame aggregation. The quantity of MPDUs is included in an AMPDU transmission from the first device 110 to the second device 120 via the communications channel 115. The first device 110 may be referred to as a transmitting device or an originator for this example. The second device 120 may be referred to as a receiving device or recipient for this example. In one embodiment, the MAC layer 102 of the first device 110 is configured to implement the frame aggregation based on MAC protocol data units. In an example, the AMPDU transmission may include 64 MPDUs in the single AMPDU PHY-level frame.

At stage B, the second device sends a block acknowledgement (BA) frame indicating which MPDUs failed. The BA frame may be generated by a Block Ack Module 128 of the second device 120. Alternatively, the BA frame may be generated by a communications unit, network interface component, processor, or other suitable components of the second device 120.

In some embodiments, the BA frame is responsive to a block acknowledgement request (BAR) frame from the first device 110 to the second device 120. In other embodiments, the second device 120 may be configured to automatically send a BA frame for each AMPDU transmission that the second device 120 receives. The BA frame includes a bitmap in which each bit represents an acknowledgement (ACK) or non-acknowledgement (NAK) of one of the MPDUs in the AMPDU transmission. For example, the bitmap may be 64 bits long, each bit representing one of the 64 MPDUs that was included in the received AMPDU transmission. A zero (“0”) value may indicate a non-acknowledgement, such as a failure to decode the MPDU. For example, the MPDU frame check sequence may not match the contents of the decoded MPDU. Alternatively, a missing MPDU may be detected based, at least in part, on a missing sequence number. For example, each MPDU in the AMPDU transmission may be associated with a sequence number. The second device 120 may determine that a MPDU was not properly received if there is a skip (i.e., “hole”) in the sequence numbers of the MPDUs that are decoded from the AMPDU transmission.

At stage C, the first device 110 may determine a transmission rate based at least in part on frame aggregation efficiency. The frame aggregation efficiency may be determined based, at least in part, on the frame aggregation feedback (e.g., the BA frame). In one embodiment, the frame aggregation efficiency may be calculated based, at least in part, on a predicted frame aggregation window size of a next AMPDU transmission. The frame aggregation window size may be responsive to which MPDUs in the previous AMPDU transmission are indicated as non-acknowledged in the BA frame.

As an example, at stage C1, the transmission rate may be based at least in part on a frame aggregation shift parameter derived from the BA frame. The frame aggregation shift parameter indicates a change in the frame aggregation window size associated with the failed MPDU in the BA frame. Using the example in FIG. 1, if the first AMPDU included 64 MPDUs and the BA frame indicates that the first MPDU failed, then the next AMPDU transmission would only include one MPDU (even if all the other 63 MPDUs were successfully received). For example, the next AMPDU transmission may include a retry attempt to send the missing MPDU in a smaller AMPDU transmission. Since only one MPDU would be included in the subsequent AMPDU, the frame aggregation shift parameter would be 63 (i.e., changing the AMPDU window size from 64 to 1 represents a shift of 63 units). If the BA frame indicates that the tenth MPDU failed, then the next AMPDU transmission would normally only includes ten MPDUs and the frame aggregation shift parameter would be 54 (i.e., changing the AMPDU window size from 64 to 10 represents a shift of 54 units).

If the frame aggregation shift parameter is above a threshold value, then the rate control module 108 may determine to reduce the PHY transmission rate. The reduced PHY transmission rate may support a smaller (or no) frame aggregation shift.

As a further example, at stage C2, the transmission rate may be based at least in part on an adjusted packet error rate (PER). Typically, a PER represents a ratio of failed MPDUs to the number of MPDUs included in the AMPDU. For example, if one (1) MPDU failed out of an AMPDU that includes 64 MPDUs, then the PER would be relatively low (1/64). However, in accordance with this disclosure, the PER may be adjusted to indicate a higher PER when the frame aggregation window size is decreasing. Similar to the frame aggregation shift parameter described with regard to stage C1, the frame aggregation window size is responsive to at least the lowest indicated MPDU failure in the BA frame. In one embodiment, the PER may be increased in proportion to the frame aggregation shift parameter. A larger frame aggregation shift parameter would result in a higher adjusted PER.

The adjustment of the PER may be useful in a device that uses the PER to determine the transmission rate. For example, a high PER may be associated with lowering the MCS. A rate control module that is already configured to utilize a PER may be used in accordance with this disclosure. For example, the adjusted PER may be calculated based on the frame aggregation feedback and the adjusted PER provided to a rate control module. By adjusting the PER based on the frame aggregation feedback, the rate control module may determine a transmission rate that is based at least in part on the frame aggregation feedback.

As an illustrative example, consider the following PER calculation in accordance with one embodiment of this disclosure:

$${PER}_{current} = 100 * ( \begin{matrix}\frac{num\_failed \_mpdus}{total\_mpdus \_in \_ampdu \_frame} + β * \\ \frac{( Block\_Ack \_Window \_Size - Block\_Ack \_Window \_Shift )}{Block\_Ack \_Window \_Size}\end{matrix} )$$

Where:
num_failed_mpdus: number of MPDUs failed in AMPDU
total_mpdus_in_ampdu_frame: total number of MPDUs in AMPDU
Block_Ack_Window_shift: the number of position shifted in the frame aggregation window because of the first hole in the AMPDU based on received BA
Block_Ack_Window_Size: size of previously used frame aggregation window (i.e. the negotiated AMPDU window size)
β: a weighting factor used to adjust the relative impact of the frame aggregation shift parameter of the formula

The PER_{current} includes a portion which increases based on quantity of failed MPDUs and also includes a portion which increases relative to the frame aggregation shift due to the first hole in the AMPDU indicated in the BA frame. The first hole relates to first failed MPDU in the series of MPDUs. Typically the first MPDU is associated the least significant bit (LSB) from the BA frame bitmap. Starting from the LSB and moving to the left, the position of the first hole would be the first zero (non-acknowledged) bit.

In some communications, the PER is a moving average or weighted based on a series of PER calculations. For example, consider the following calculation:

PER_{Average}=(1−α)*PER_{Previous}+α*PER_{Current}

Where α is a weighting factor (0<=α<=1)

Because the PER_{current} is adjusted based, at least in part, on the frame aggregation window shift parameter, the rate control module 108 may utilize existing algorithms for determining the transmission rate based on PER. For example, the rate control module 108 may decrease the transmission rate (using a lower MCS) if the PER is above a predefined threshold. Because the PER is penalized greater for larger frame aggregation window shift values, the rate control module 108 may use a lower transmission rate. However, the lower transmission rate may provide more reliable communications to support greater frame aggregation window sizes. The frame aggregation efficiency may be improved for the lower transmission rate. Therefore, the actual data throughput may increase despite the lower transmission rate.

The efficiency of frame aggregation decreases as PER increases. For example, when the PER is only 5% the aggregation size is dropped from 64 MPDUs to 38 MPDUs in the AMPDU window size. The effect of PER on aggregation size is more pronounced for higher PHY data rates. While aggregation size is more efficient at the higher PHY data rates, small increases in PER may have dramatic effects. Therefore, by adjusting the PER or by taking into account the aggregation size in the selection of a transmission rate, the efficiency of the communications channel may be improved.

Empirically, a communications channel having −81 dBm attenuation may have random holes in the frame aggregation mechanism when using Modulation Coding Scheme 7 (MCS7). The same communications channel may have relatively fewer frame aggregation holes when using Modulation Coding Scheme 5 (MCS5). In one example, the rate control module may use the unadjusted PER (e.g., not using an adjustment that is based on the frame aggregation shift parameter) to determine the transmission rate. The rate control module may select MCS7 based on the unadjusted PER. However, the use of MCS7 may yield poor throughput due to BA holes in the frame aggregation feedback causing smaller frame aggregation window sizes. In another example, the rate control module may use the adjusted PER which incorporates an adjustment based on the frame aggregation shift parameter. In other words, the adjusted PER may be higher if the frame aggregation shift is higher. In this example, the rate control module may select MCS5 based on the adjusted PER value. Comparing the two examples, the overall throughput for MCS7 may be found to be 540 mps for User Datagram Protocol (UDP) traffic using frame aggregation, while the overall throughput for MCS5 may be found to be 602 mps for the same UDP traffic using frame aggregation. Therefore, in accordance with the PER calculations in this disclosure, the lower transmission rate (MCS5) may be selected.

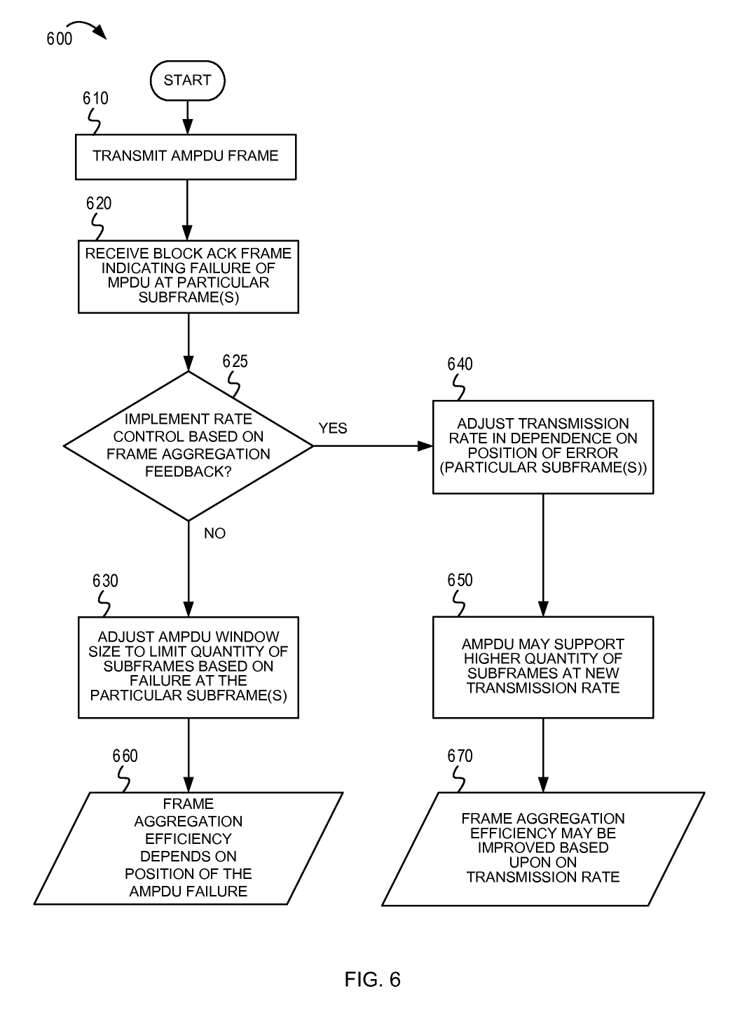

Further examples of the frame aggregation shift parameter are provided in FIGS. 6-8 of this disclosure.

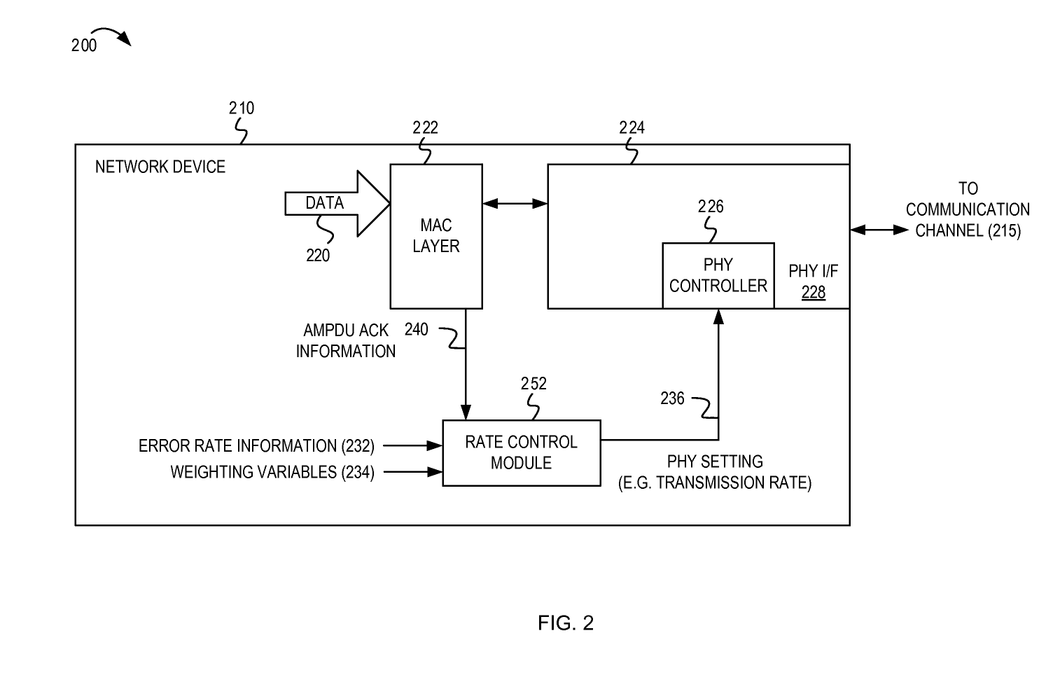

FIG. 2 is a block diagram 200 illustrating an example network device 210 having a rate control module 252 in accordance with various embodiments of the present disclosure. In some implementations, data 220 to be transmitted can be received by MAC layer 222. MAC layer 222 can provide a data interface between components and modules within network device 210 and the communications channel 215 through PHY layer 224. Data from MAC layer 222 can be processed by the PHY layer 224 and transmitted via a physical interface 228 capable of coupling to the communications channel 215. A PHY controller 226 may manage modulation, forward error correction, or other physical layer transmission properties for the PHY layer 224.

A rate control module 252 can provide PHY settings (shown as arrow 236) to the PHY controller 226 in PHY layer 224. The provided PHY settings can include an initial transmission rate setting as described in stage C above. In one embodiment, PHY controller 226 can determine modulation characteristics for data to be transmitted into communications channel 215 based, at least in part, on the PHY settings 236. PHY layer 224 can transmit data from MAC layer 222 at the data rate determined by rate control module 252 via the communications channel 215.

The rate control module 252 may include inputs such as error rate information 232 (such as bit error rate or traditional packet error rate) or weighting variables 234 (such as α or β described above). In accordance with an embodiment of this disclosure, the rate control module 252 may also receive AMPDU acknowledgement information 240 from the MAC layer 222. For example, the frame aggregation feedback in the BA frame may be converted to a frame aggregation shift parameter or block acknowledgement window size based, at least in part, on the position of a first hole in the BA frame.

Because the rate control module 252 is responsive to the frame aggregation feedback information, the rate control module 252 may determine a PHY settings 236 (e.g., transmission rate) in dependence upon the frame aggregation shift characteristics described above.

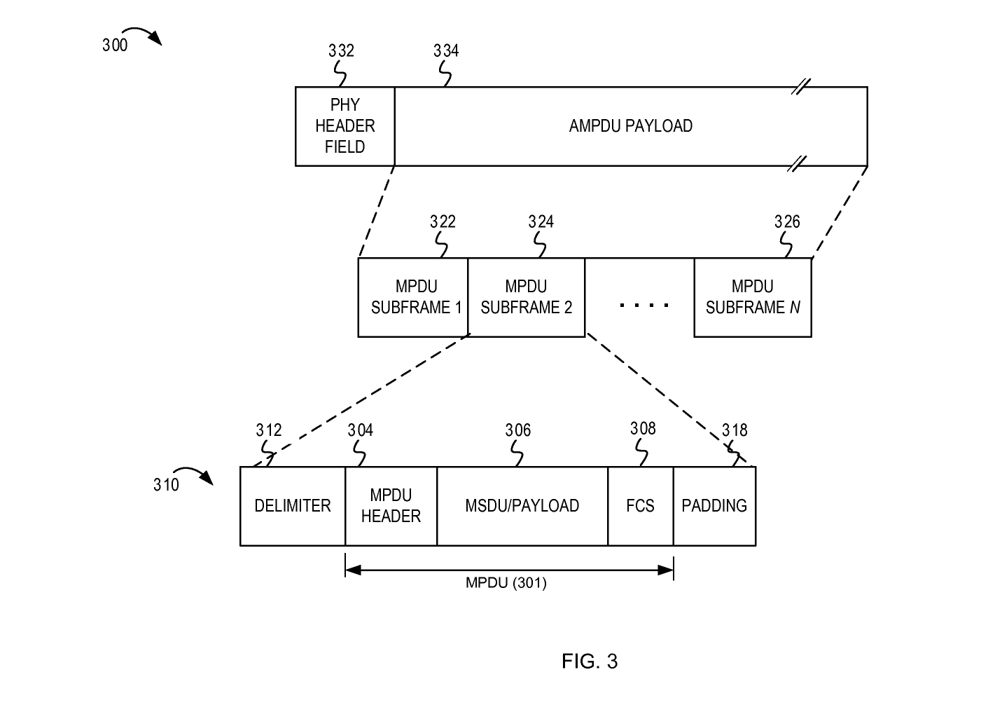

FIG. 3 is a diagram illustrating an example AMPDU frame format 300 in accordance with various embodiments of the present disclosure. The AMPDU frame format 300 may include a PHY header field 332 portion and an AMPDU payload 334 portion. The AMPDU payload 334 includes a plurality of MPDUs. The MPDUs are structured as MPDU subframes (such as MPDU subframe “1” 322, MPDU subframe “2” 324, and MPDU subframe “N” 326) within the AMPDU payload 334.

Each MPDU subframe may have a structure similar to example MPDU subframe 310. The example MPDU subframe 310 includes a delimiter field 312, an MPDU 301, and padding 318. The MPDU 301 may comprise an MPDU header 304, a payload 306, and a frame check sequence (FCS) 308. Typically the payload 306 of the MPDU may include a MAC service data unit (MSDU).

It should be understood that the quantity of MPDU subframes included in the AMPDU frame may be variable. In accordance with some WLAN standards, the quantity of MPDU subframes may be limited to a maximum of 64 units. Furthermore, the quantity of MPDU subframes may be selectable from fixed predetermined quantities (e.g., 1, 2, 4, 8, 16, 32, or 64).

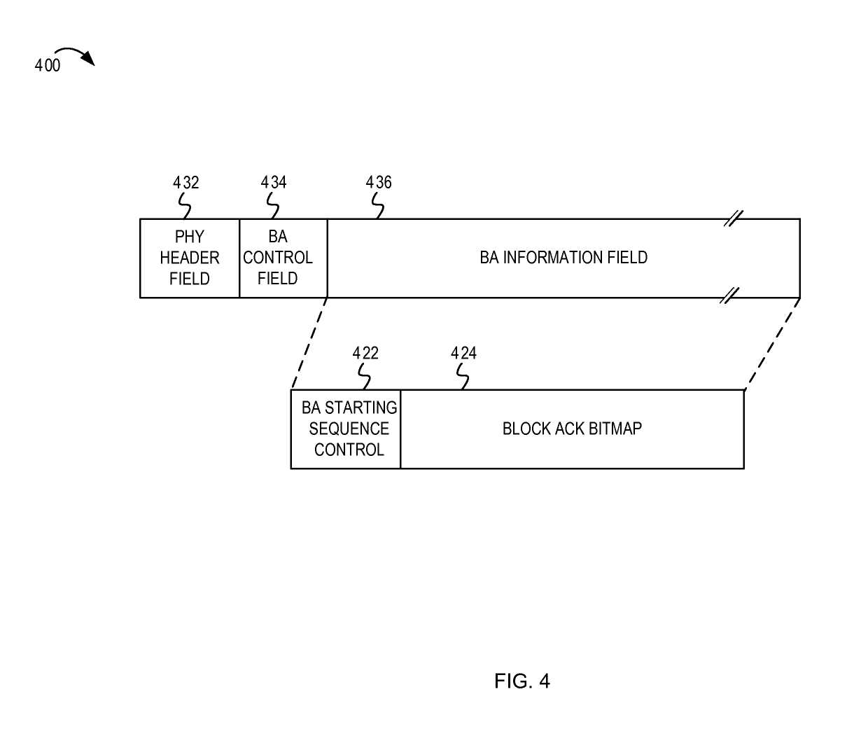

FIG. 4 is a diagram illustration an example block acknowledgement (BA) frame 400 in accordance with various embodiments of the present disclosure. The BA frame 400 may include a PHY frame header field 432, a BA control field 434 and a BA information field 436. The BA control field 434 may provide information regarding the size or structure of the BA information field 436.

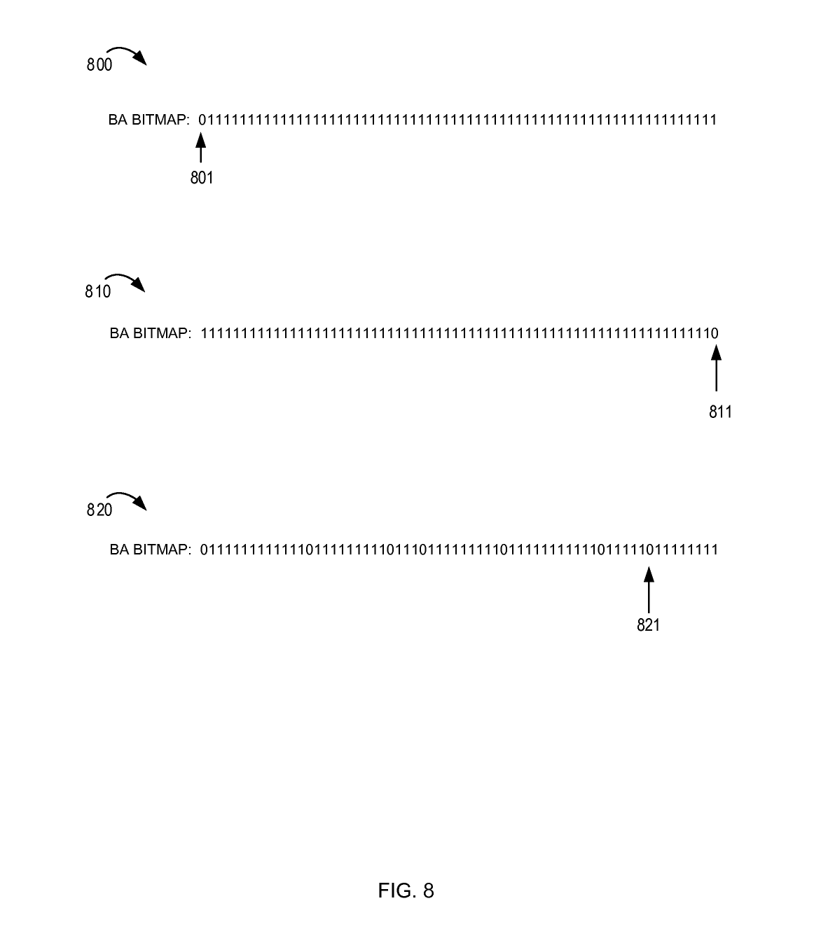

In one example, the BA information field 436 may include a BA starting sequence control 422 and a BA bitmap 424. The BA starting sequence control 422 includes a value to indicate the first sequence number of the MPDUs acknowledged by the BA frame 400. The BA bitmap 424 may include one or more bits for each MPDU acknowledged (or non-acknowledged) in the BA frame 400. FIG. 8 includes examples of bitmaps that may be included in the BA bitmap 424 of a BA frame using compressed block acknowledgement.

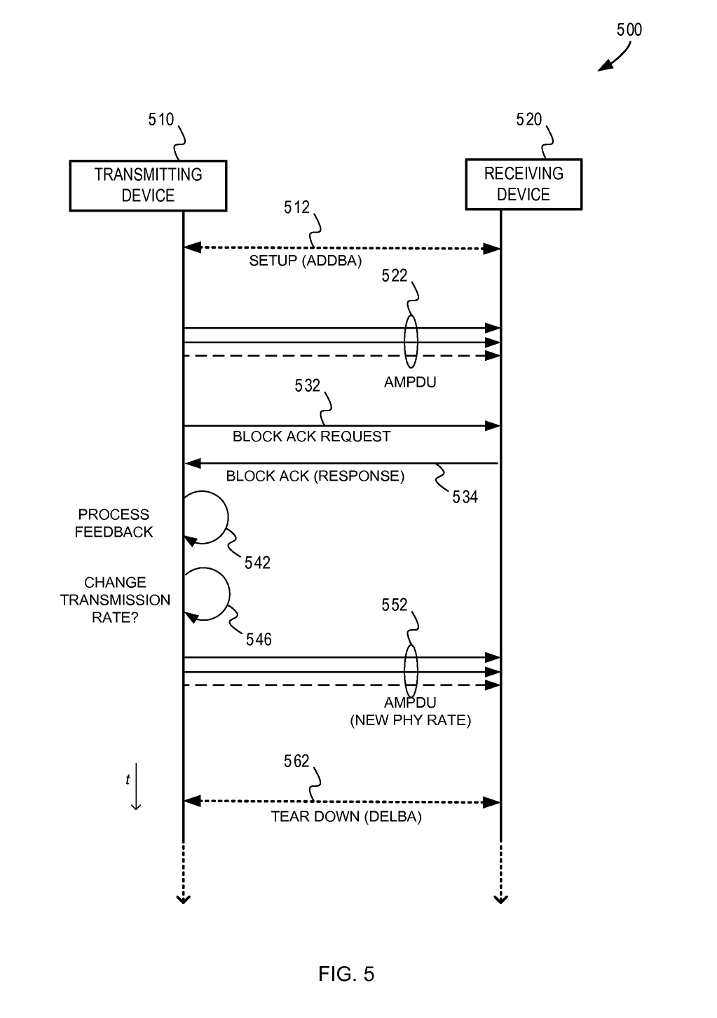

FIG. 5 is a message flow diagram 500 illustrating frame aggregation, frame aggregation feedback, and rate control in accordance with an embodiment of the present disclosure. In the message flow diagram 500, a first device is defined as a transmitting device 510 and a second device is defined as a receiving device 520. It should be understood that the transmitting device 510 may be capable of both transmitting and receiving messages. Similarly, the receiving device 520 may be capable of both transmitting and receiving messages. However for purposes of this example diagram, the transmitting device 510 has data which is to be transmitted to the receiving device 520 via a communications channel.

The transmitting device 510 and receiving device 520 are coupled via a communications channel that supports frame aggregation. Block acknowledgement may be used with the frame aggregation to improve the efficiency of the communications channel. Block acknowledgement consists of a setup and a tear-down phase. In the setup phase, capability information such as buffer size and BA policy are negotiated with the receiver.

At 512, the transmitting device 510 and receiving device 520 may exchange messages to negotiate or setup a block acknowledgement scheme. For example, the transmitting device 510 may send a BA setup message (referred to as “ADDBA”) to the receiving device 520 and wait for an acknowledgement from the receiving device 520 before determining that the block acknowledgement scheme is activated. The ADDBA message may also include a block acknowledgement policy. For example, a parameter may indicate the type of BA scheme requested (e.g., immediate block ack, delayed block ack, or normal block ack) or whether compressed BA is permitted.

At 522, the transmitting device 510 may transmit an AMPDU frame to the receiving device 520. The AMPDU frame may include a plurality of MPDUs. For example, the AMPDU frame may be formatted similar to the example AMPDU frame described in FIG. 3.

At 532, the transmitting device 510 may send a Block Ack Request (BAR) frame to the receiving device 520 to request acknowledgement of the MPDUs included in the AMPDU frame.

The transmitting device 510 may include a Block Ack starting sequence control value in the BAR frame to signal the first MPDU in the block for which an acknowledgment is expected. MPDUs in the receiving device's 520 buffer with a sequence control value that precedes the starting sequence control value may be called preceding MPDUs. The receiving device 520 may reassemble any complete MSDUs from buffered preceding MPDUs and indicate these to its higher layer. The receiving device 520 may maintain a Block Ack record consisting of originator address, and a record of reordering buffer size indexed by the received MPDU sequence control value. This record holds the acknowledgment state of the data frames received from the transmitting device 510.

At 534, the receiving device 520 may respond with a Block Ack (BA) frame. The BA frame may be formatted similar to the example BA frame described in FIG. 4. For example, the receiving device 520 may respond with a Basic BlockAck frame. The Basic BlockAck frame includes acknowledgments for the MPDUs of up to 64 previous MSDUs. In the Basic BlockAck frame, the receiving device 520 acknowledges only the MPDUs starting from the starting sequence control until the MPDU with the highest sequence number that has been received, and the receiving device 520 may set bits in the Block Ack bitmap corresponding to all other MPDUs (not received) to zero. At 542, the transmitting device 510 may process the BA frame to determine, among other characteristics, a frame aggregation shift parameter. The frame aggregation shift parameter may be associated with a position of the first hole in the block acknowledgement. The frame aggregation shift parameter may be a value associated with changing the frame aggregation window size for a subsequent AMPDU frame. If the transmitting device 510 receives a Basic BlockAck frame, the transmitting device 510 processes the Basic BlockAck frame (at 542) to update its own record. The transmitting device 510 may retry transmitting any frames that are not acknowledged in the Basic BlockAck frame, either in another block or individually. For example, if the Basic BlockAck frame indicates that an MPDU was not received correctly, the transmitting device 510 may retry that MPDU subject to that MPDU's appropriate lifetime limit.

At 546, the transmitting device 510 may determine whether to change the transmission rate based at least in part upon the frame aggregation shift parameter. For example, the transmitting device 510 may compare the frame aggregation efficiency associated with a first option (e.g., using the current transmission rate and a frame aggregation window size reduced by the frame aggregation shift parameter) with the frame aggregation efficiency of a second option (e.g., using a different transmission rate with less or no reduction in the frame aggregation window size). In accordance with an embodiment of this disclosure, the transmitting device 510 selects a different transmission rate based on a probability for greater throughput resulting from the change in transmission rate.

It should be understood that in some embodiments, the transmitting device 510 communicates the change in transmission rate to the receiving device 520 prior to transmitting frames using the new transmission rate. In some embodiments, the PHY header of a subsequent frame may indicate the new transmission rate. In other embodiments, a separate message may be transmitted to indicate the change in transmission rate to the receiving device 520.

At 552, the transmitting device 510 transmits a subsequent AMPDU frame using the new transmission rate. In some embodiments, the quantity of aggregated MPDUs may be the same as the quantity of MPDUs included in the previous AMPDU frame, e.g., when the transmitting device 510 starts with new AMPDU.

At 562, the block acknowledgement session may be terminated using a tear down process. For example, a tear down message (referred to as “DELBA”) may be used to communicate the end of the block acknowledgement session.

FIG. 6 is a flow diagram 600 illustrating example operations associated with processing frame aggregation feedback in accordance with various embodiments of the present disclosure.

At 610, a device may transmit an AMPDU frame. At 620 the device may receive a block acknowledgement (BA) frame indicating failure of an MPDU at a particular position in the AMPDU frame. For example, a hole in a particular position of the BA bitmap is associated with a non-acknowledged MPDU at a corresponding position (subframe) in the AMPDU frame.

At 625, the flow diagram 600 includes a decision whether to implement rate control based on the frame aggregation feedback. In some embodiments, a device may be capable of enabling or disabling the improved rate control feature. Alternatively, the improved rate control feature may be toggled based, at least in part, on a threshold decision upon analyzing the BA frame. If the improved rate control feature is not implemented or not enabled, the flow continues to block 630. If the improved rate control feature is implemented and enabled, then the flow continues to block 640.

At 630, the AMPDU window size is adjusted based on the failures indicted in the BA frame. The AMPDU window size may be decreased to limit the quantity of MPDUs included in the next AMPDU transmission. For example, the position of the first failed MPDU may be used as a limit on the AMPDU window size. As a result, at block 660, the frame aggregation efficiency depends on the position of the failed MPDU in the previous AMPDU transmission.

If improved rate control is used, the flow continues to block 640. At block 640, the PHY transmission rate may be adjusted in dependence on the position of the failed MPDU in the previous AMPDU transmission. For example, the transmission rate may be decreased if the position of the failed MPDU is associated with causing a smaller frame aggregation window size (at block 630).

At block 650, due to the adjustment of the transmission rate, the subsequent AMPDU transmission(s) may support a higher quantity of MPDUs. For example, if the transmission rate is decreased to a more reliable (e.g., lower error rate) state, then the frame aggregation may utilize a larger frame aggregation window size. Having a larger frame aggregation window size reduces PHY overhead and increases upper layer data throughput. Therefore, at block 670, the frame aggregation efficiency may be improved based, at least in part, on the new transmission rate.

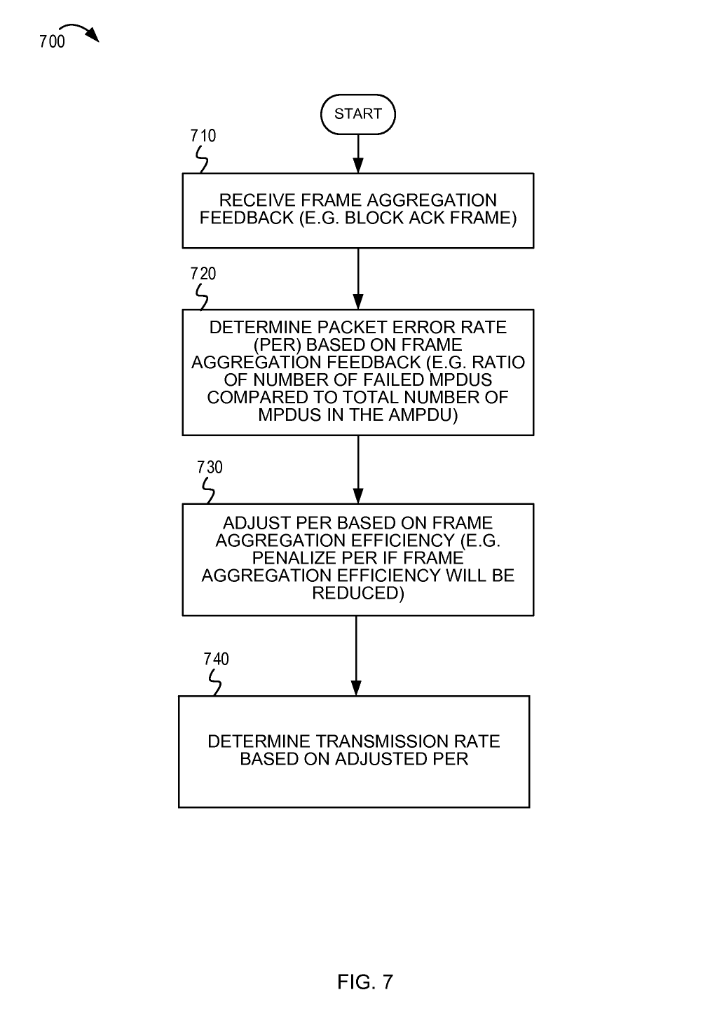

FIG. 7 is a flow diagram 700 illustrating example operations associated with determining a transmission rate based on frame aggregation feedback in accordance with various embodiments of the present disclosure.

At 710, an operation may include a device receiving frame aggregation feedback. For example, the frame aggregation feedback may be in the form of a block acknowledgement (BA) frame.

At 720, the device may determine a packet error rate (PER) based on the frame aggregation feedback. For example, the PER may include a calculation of a ratio of number of failed MPDUs indicated by the BA frame compared to the total number of MPDUs transmitted.

At 730, an operation may include adjusting the PER based on an adjustment factor (such as a frame aggregation shift parameter or projected frame aggregation window size) that correlates to frame aggregation efficiency. As an example, the adjusted PER may be considered “penalized” (i.e., a higher PER) if the frame aggregation efficiency will drop as a result of the frame aggregation shift parameter or projected frame aggregation window size. When the adjusted PER is higher, the rate control module is more likely to reduce the transmission rate.

At 740, an operation includes determining a transmission rate based on the adjusted PER. In some embodiments, the transmission rate may be determined by a look up table that compares a PER value with a threshold value for the current transmission rate. When the PER is higher than a threshold value, the transmission rate is decreased.

FIG. 8 is a conceptual diagram illustrating several examples 800, 810, 820 of frame aggregation feedback in accordance with various embodiments of the present disclosure. Each example shows possible scenarios for a block acknowledgement bitmap in a BA frame. Each block acknowledgement bitmap includes 64 bits representing each of a 64 MPDUs that were transmitted in an AMPDU frame. In these examples, a compressed block acknowledgement scheme is depicted. The least significant bit (LSB) represents the first MPDU included in the AMPDU frame and each MPDU (in the order they are in the AMPDU frame) are represented by bits from the LSB moving left towards the most significant bit (MSB). The first and second examples 800, 810 represent two idealistic extremes to better show the impact of the frame aggregation shift parameter on the transmission rate.

In a first example 800, the BA bitmap includes a zero 801 in the most significant bit (MSB) which is associated with the last MPDU (i.e., the 64^{th} MPDU) that was included in the AMPDU transmission. The raw packet error rate for this example would be 1 failed MPDU divided by 64 transmitted MPDUs in the AMPDU frame (1/64 expressed as a percentage is roughly 1.5%). The frame aggregation shift parameter would also be fairly small. For example, the next AMPDU would include 63 frames (rather than 64 frames) so the frame aggregation shift parameter would be 1. Therefore the frame aggregation shift parameter will have very little effect on the adjusted PER. The adjusted PER is still fairly low, so the rate control module may leave the transmission rate unchanged or may increase the transmission rate. In other words, frame aggregation remains efficient at the current transmission rate, so there is no need to reduce the transmission rate. Whether the rate control module is configured to use the frame aggregation shift parameter directly or use the adjusted PER, the rate control module may determine a higher transmission rate remains possible while still maintaining high frame aggregation efficiency.

In the second example 810, the BA bitmap includes a zero 811 in the LSB which is associated with the first MPDU (i.e., the 1^{st} MPDU) that was included in the AMPDU transmission. The raw packet rate for this example is the same as in example 800—specifically 1 failed MPDU divided by 64 transmitted MPDUs in the AMPDU frame. However, the frame aggregation shift parameter is much higher in the second example 810. Because the first MPDU failed (even though the rest of the MPDUs may have been successful), the transmitting device may send a subsequent AMPDU having only one MPDU. For example, the transmitting device may be configured to set the frame aggregation window size based, at least in part, on the number of MPDUs that are acknowledged in the BA bitmap before encountering a non-acknowledged MPDU in the BA bitmap. The frame aggregation shift parameter would be 63 (i.e., shifting the frame aggregation window size from 64 MPDUs to 1 MPDU). Therefore the frame aggregation shift parameter will have a large effect on the adjusted PER. For example, the adjusted PER would be very high (perhaps 100%) using the formula for PER_{current} described previously. The rate control module would likely reduce the transmission rate due to the high adjusted PER. In other words, frame aggregation would not be efficient at the current transmission rate, so there is a need to reduce the transmission rate. The lower transmission rate may allow for more frame aggregation window size than what would be used at the higher transmission rate.

Comparing the first example 800 and second example 810 as extreme scenarios, one aspect to point out is that the number of failed MPDUs in both examples is the same: only one failed MPDU. However, because of the position of the failed MPDU in the previous AMPDU transmission, the subsequent AMPDU transmission would have very different window sizes. Therefore, the position of the first failed MPDU greatly impacts the frame aggregation efficiency.

Example 820 is provided as a more realistic scenario. Random MPDU failures (“0”) 821 are indicated in the BA bitmap. The quantity of MPDU failures will impact the raw (unadjusted) PER. The position of the first failure may be indicated at different points in the BA bitmap. Therefore, a calculation similar to the one described above for PER_{current} may take into account both the raw PER as well as an adjustment based, at least in part, on the frame aggregation shift parameter. In one embodiment, a pre-defined algorithm may be used to calculate the adjusted PER prior to sending the adjusted PER to the rate control module. In other embodiments, the rate control module may be modified to utilize the unadjusted PER (or other parameters) in addition to the frame aggregation shift parameter to determine whether to change the transmission rate. The resulting PHY transmission rate for a next AMPDU transmission may be determined based on the position of the first error in the BA bitmap for the most recent AMPDU transmission.

Turning now to another example embodiment, the effect of aggregation size on goodput is also considered. Aggregation size may have a direct impact on MAC efficiency and the throughput.

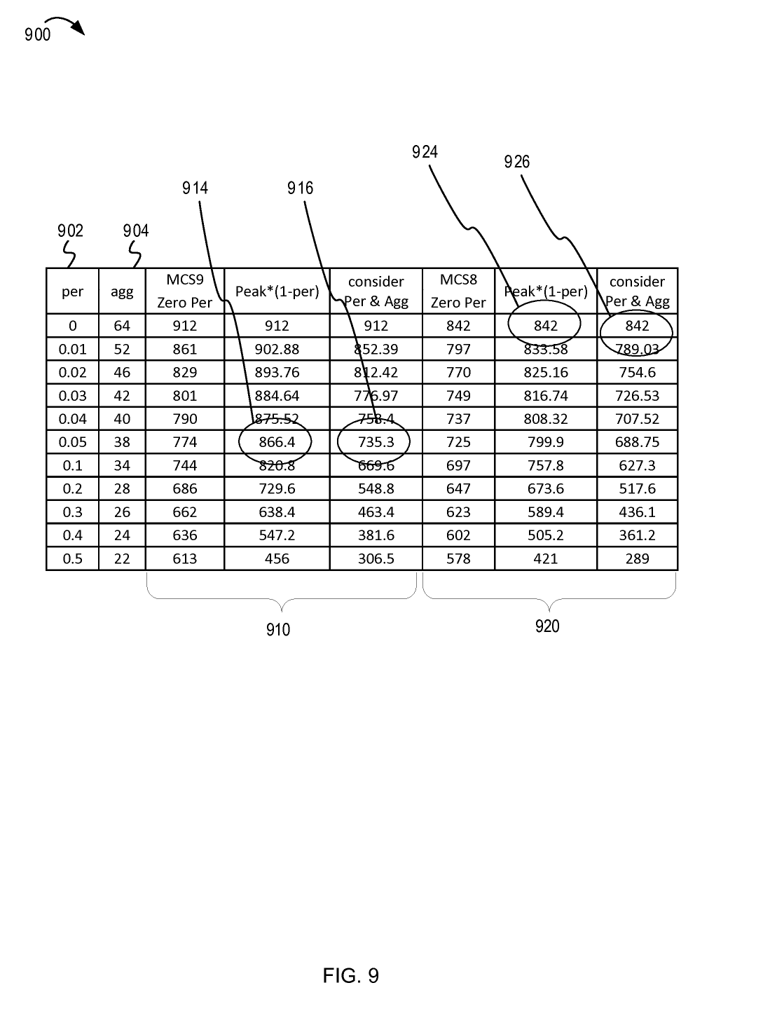

FIG. 9 shows a table 900 associated with very high throughput (e.g., IEEE 802.11ac protocol using vht80, 3stream, half GI) with UDP saturated throughput using both MCS9 (shown in columns 910) and MCS8 (shown in columns 920). The column of “MCS9 Zero Per” shows the throughput with the corresponding aggregation size, assuming zero PER. It shows the maximum throughput achievable with limited aggregation size. The column of “peak*(1−per)” shows the throughput with the corresponding PER, but assuming maximum aggregation (64 in this case).

The table shows that a rate control algorithm that does not consider the aggregation factor will choose the non-optimal rate. For example, in a scenario where MCS8 has 0 PER and MCS9 has 0.05 PER:
Without consideration the impact of aggregation, MCS9 would be calculated as 866.4 Mbps (at reference 914). MSC8 would be calculated as 842 Mbps (at reference 924). Because MCS9 appears to have a higher calculated throughput, the traditional rate control module may select MCS9. However, the actual throughput with the effect of frame aggregation size might only be 735 Mbps (at reference 916).
With consideration of the impact of aggregation: MSC9 would be calculated as 735.3 Mbps (at reference 916) and MCS8 would be calculated as 842 Mbps (at reference 926). Therefore, the improved rate control module configured to include the impact of aggregation size would select MCS8 and the actual throughput would be 842 Mbps (at reference 926).

It should be understood that FIGS. 1-9 and the operations described herein are examples meant to aid in understanding embodiments and should not be used to limit embodiments or limit scope of the claims. Embodiments may perform additional operations, fewer operations, operations in parallel or in a different order, and some operations differently.

As will be appreciated by one skilled in the art, aspects of the present subject matter may be embodied as a system, method, or computer program product. Accordingly, aspects of the present subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

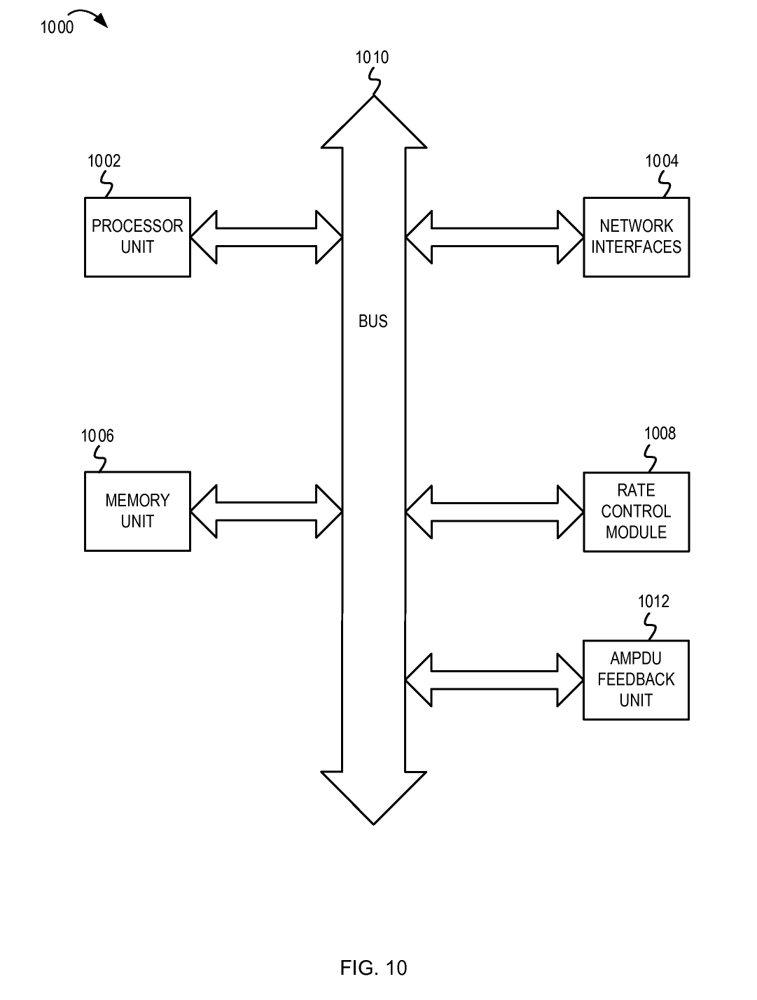

FIG. 10 is an example block diagram of one embodiment of an electronic device 1000 including rate control module 1008 configured to determine a transmission rate based, at least in part, on frame aggregation feedback in accordance with various embodiments of this disclosure. In some implementations, the electronic device 1000 may be one of a laptop computer, a netbook, a mobile phone, a powerline communication device, a personal digital assistant (PDA), or other electronic systems. The electronic device 1000 includes a processor unit 1002 (possibly including multiple processors, multiple cores, multiple nodes, and/or implementing multi-threading, etc.). The electronic device 1000 includes a memory unit 1006. The memory unit 1006 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 1000 also includes a bus 1010 (e.g., PCI, ISA, PCI-Express, HyperTransport®, InfiniBand®, NuBus, AHB, AXI, etc.), and network interfaces 1004 that include at least one of a wireless network interface (e.g., a WLAN interface, a Bluetooth® interface, a WiMAX interface, a ZigBee® interface, a Wireless USB interface, etc.). In some implementations, the electronic device 1000 may support more than one network interface—each of which is configured to couple the electronic device 1000 to a different communication network.

The electronic device 1000 also includes a rate control module 1008. As described above in FIGS. 1-9, the rate control module 1008 may implement functionality to determine a transmission rate based, at least in part, on frame aggregation feedback. The electronic device 1000 may include an AMPDU feedback unit 1012 for processing frame aggregation feedback information. For example, the AMPDU feedback unit 1012 may implement functionality to determine a frame aggregation shift parameter or adjustment factor used to adjust a packet error rate as described in the previous descriptions. In some embodiments, the AMPDU feedback unit 1012 and/or the rate control module 1008 may be implemented entirely or partially as software executed by an operating system of a computer system. Alternative, any one of these functionalities may be partially (or entirely) implemented in hardware and/or on the processor unit 1002. For example, the functionality may be implemented with an application specific integrated circuit, in logic implemented in the processor unit 1002, in a co-processor on a peripheral device or card, etc. Further, realizations may include fewer or additional components not illustrated in FIG. 10 (e.g., video cards, audio cards, additional network interfaces, peripheral devices, etc.). The processor unit 1002, the memory unit 1006, and the network interfaces 1004 are coupled to the bus 1010. Although illustrated as being coupled to the bus 1010, the memory unit 1006 may be coupled to the processor unit 1002.

While the embodiments are described with reference to various implementations and exploitations, it will be understood that these embodiments are illustrative and that the scope of the inventive subject matter is not limited to them. In general, techniques for determining a transmission rate based at least in part upon frame aggregation feedback information as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A method comprising:
transmitting a first series of media access control (MAC) protocol data units (MPDUs) as a first aggregated MPDU (AMPDU) transmission;
receiving a block acknowledgement frame indicating at least a first non-acknowledged MPDU from the first AMPDU transmission; and
determining a physical layer (PHY) transmission rate for a subsequent AMPDU transmission based, at least in part, on a position of the first non-acknowledged MPDU in the first series of MPDUs.

2. The method of claim 1, further comprising:
determining a frame aggregation shift parameter based, at least in part, on the position of the first non-acknowledged MPDU in the first series of MPDUs.

3. The method of claim 2, further comprising:
adjusting a frame aggregation window size for the subsequent AMPDU transmission based at least in part on the frame aggregation shift parameter.

4. The method of claim 2, further comprising:
adjusting the PHY transmission rate for the subsequent AMPDU transmission based at least in part on the frame aggregation shift parameter.

5. The method of claim 4, further comprising:
adjusting a frame aggregation window size for the subsequent AMPDU transmission based at least in part on the frame aggregation shift parameter and the PHY transmission rate, wherein the frame aggregation window size is increased from a window size associated with the frame aggregation shift parameter if the PHY transmission rate is decreased.

6. The method of claim 1, wherein determining the PHY transmission rate includes:
determining a projected frame aggregation window size for the subsequent AMPDU transmission based, at least in part, on the position of the first non-acknowledged MPDU in the first series of MPDUs, wherein the PHY transmission rate changes in dependence on the projected frame aggregation window size.

7. The method of claim 6, wherein said determining the PHY transmission rate includes:
adjusting a packet error rate based, at least in part, on the projected frame aggregation window size; and
utilizing the adjusted packet error rate to determine the PHY transmission rate.

8. The method of claim 6, wherein the determined PHY transmission rate is decreased in response to the projected frame aggregation window size falling below a threshold value.

9. The method of claim 8, wherein an actual frame aggregation window size used for the subsequent AMPDU transmission is greater than the projected frame aggregation window size.

10. The method of claim 6, wherein the determined PHY transmission rate is decreased in proportion to the projected frame aggregation window size.

11. The method of claim 1, wherein the determined PHY transmission rate for the subsequent AMPDU transmission is lower than a previous PHY transmission rate used to transmit the first A MPDU transmission.

12. An apparatus comprising:
a media access control (MAC) protocol layer configured to prepare a first series of media access control (MAC) protocol data units (MPDUs) as a first aggregated MPDU (AMPDU) transmission;
a physical interface capable of coupling to a communications medium and configured to transmit the first AMPDU transmission via the communications medium;
the physical interface configured to receive a block acknowledgement frame indicating at least a first non-acknowledged MPDU from the first AMPDU transmission; and
a rate control module configured to determine a physical layer (PHY) transmission rate for a subsequent AMPDU transmission based, at least in part, on a position of the first non-acknowledged MPDU in the first series of MPDUs.

13. The apparatus of claim 12, further comprising:
a frame aggregation feedback module configured to determine a frame aggregation shift parameter based, at least in part, on the position of the first non-acknowledged MPDU in the first series of MPDUs.

14. The apparatus of claim 13, wherein the frame aggregation feedback module is further configured to adjust a frame aggregation window size for the subsequent AMPDU transmission based at least in part on the frame aggregation shift parameter.

15. The apparatus of claim 13, wherein the rate control module is further configured to adjust the PHY transmission rate for the subsequent AMPDU transmission based at least in part on the frame aggregation shift parameter.

16. The apparatus of claim 15, wherein the frame aggregation feedback module is further configured to adjust a frame aggregation window size for the subsequent AMPDU transmission based at least in part on the frame aggregation shift parameter and the PHY transmission rate, wherein the frame aggregation window size is increased from a window size associated with the frame aggregation shift parameter if the PHY transmission rate is decreased.

17. The apparatus of claim 13, wherein the rate control module is being configured to determine the PHY transmission rate includes the rate control module is being configured to:
determine a projected frame aggregation window size for the subsequent AMPDU transmission based, at least in part, on the position of the first non-acknowledged MPDU in the first series of MPDUs, wherein the PHY transmission rate changes in dependence on the projected frame aggregation window size.

18. The apparatus of claim 17, wherein the rate control module is being configured to determine the PHY transmission rate includes the rate control module is being configured to:
adjust a packet error rate based, at least in part, on the projected frame aggregation window size; and
utilize the adjusted packet error rate to determine the PHY transmission rate.

19. The apparatus of claim 17, wherein the determined PHY transmission rate is decreased in response to the projected frame aggregation window size falling below a threshold value.

20. The apparatus of claim 19, wherein an actual frame aggregation window size used for the subsequent AMPDU transmission is greater than the projected frame aggregation window size.

21. The apparatus of claim 17, wherein the rate control module is being configured to determine the PHY transmission rate includes the rate control module is being configured to decrease the determined PHY transmission rate in proportion to the projected frame aggregation window size.

22. A non-transitory computer readable medium storing computer program code, the computer program code comprising instructions which when executed by a processor of a device cause the device to:
transmit a first series of media access control (MAC) protocol data units (MPDUs) as a first aggregated MPDU (AMPDU) transmission;
receive a block acknowledgement frame indicating at least a first non-acknowledged MPDU from the first AMPDU transmission; and
determine a physical layer (PHY) transmission rate for a subsequent AMPDU transmission based, at least in part, on a position of the first non-acknowledged MPDU in the first series of MPDUs.

23. The non-transitory computer readable medium of claim 22, the computer program code further comprising instructions which when executed by a processor of a device cause the device to:
determine a frame aggregation shift parameter based, at least in part, on the position of the first non-acknowledged MPDU in the first series of MPDUs.

24. The non-transitory computer readable medium of claim 23, the computer program code further comprising instructions which when executed by a processor of a device cause the device to:
adjust the PHY transmission rate for the subsequent AMPDU transmission based at least in part on the frame aggregation shift parameter.

25. The non-transitory computer readable medium of claim 24, the computer program code further comprising instructions which when executed by a processor of a device cause the device to:
adjust a frame aggregation window size for the subsequent AMPDU transmission based at least in part on the frame aggregation shift parameter and the PHY transmission rate, wherein the frame aggregation window size is increased from a window size associated with the frame aggregation shift parameter if the PHY transmission rate is decreased.
